(19) United States
(12) Patent Application Publication
(10) Pub. No.: US 2007/0083863 A1
(43) Pub. Date: Apr. 12, 2007

(54) Method and system for restrained budget use

(75) Inventors: Reinder Jaap Bril, Waalre (NL); Elisabeth Francisca Maria Steffens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,159

(22) PCT Filed: Nov. 11, 2004
(86) PCT No.: PCT/IB04/52397

§ 371 Date: May 12, 2006

Related U.S. Application Data
(60) Provisional application No. 60/519,811, filed on Nov. 13, 2003.

(51) Int. Cl. G06F 9/46

(52) U.S. Cl. 718/100

(57) ABSTRACT

A method (60) for controlling multiple tasks in a real-time operating system (110, 170) assigns priorities to two or more tasks (114, 115; 174, 175). A first task (114; 174) is assigned to be a More Important Task. A second task (115; 175) is assigned to be a Less Important Task. Each task is explicitly informed of its budget allocations. A Guaranteed Budget Margin is then allocated to the More Important Task along with a More Important Guaranteed Budget. A Less Important Guaranteed Budget is also allocated to the Less Important Task. At some point during execution, the higher priority or More Important Task (114; 174) may then determine that the More Important Task no longer requires the Guaranteed Budget Margin, in which case, a Conditionally Guaranteed Budget Margin is then allocated to the Less Important Task (115; 175).

The present invention relates generally to methods and apparatuses for managing resources in operating systems, and more particularly to a method and apparatus for managing resources in an operating system that functions in real-time.

High volume electronics (HVE) consumer systems, such as digital television sets, digitally improved analog television sets and set top boxes (STBs), are typically part of product families, which are required to become open and flexible, while remaining cost-effective and robust. Such systems have properties that are characteristics of the hard real-time domain.

As openness and flexibility are typical characteristics of software based systems, significant parts of the media processing in HVE consumer systems are expected to become implemented in software, in addition to the existing software realizations for control and services. Component technology is considered to be basic technology for open and flexible systems. Note that because HVE consumer systems are typically part of product families, component technology is already very important for existing software intensive HVE consumer systems; developing such systems using component technology significantly reduces the development lead-time and the development cost, amongst others benefits.

Moreover, consumer products are heavily resource constrained. As a consequence, the available resources must be used very cost effectively, while preserving typical qualities of HVE consumer systems, such as robustness, and meeting stringent timing requirements imposed by, for example, high quality digital audio and video processing. Concerning robustness, no one expects, for example, a television set to stall with the message “please reboot the system.” The notion of resource budgets (or reservations) is a proven concept to provide temporal isolation between applications.

Currently work exists with a system implementing budgets on top of a commercial-off-the-shelf (COTS) real-time operating system (RTOS) providing fixed-priority preemptive scheduling (FPPS).

U.S. Pat. No. 5,838,968 discloses a system and method for dynamic resource management across tasks in real-time operating systems. The system and method manage an arbitrary set of system resources and globally optimize resource allocation across system tasks in a dynamic fashion, according to a system specified performance model.

U.S. Patent Application Publication No. US 2002/0138679 A1 discloses a system and method for priority inheritance, in which the method tests a priority inheritance variable associated with a task, and lowers the current priority of a task when testing the priority inheritance variable indicates that the task holds no resources that are involved in a priority inheritance. U.S. Patent Application Publication No. US 2002/0133530 A1 discloses a method for resource control that includes resource stealing by a higher priority task from a lower priority tasks. In some cases, budget allocations are less than ideal, which can lead to inflexible operation or improper use of resources.

The present invention is therefore directed to the problem of developing a method and apparatus for improving resource use in reservation-based scheduling in real-time operating systems as well as other similar applications.

The present invention solves these and other problems by providing a method for controlling an operating system that combines the concepts of multiple task prioritization, resource budgeting, resource consumption prediction, and conditional budget allocation. In this combination, a budget margin is allocated to a higher priority task, to be used in case its budget is not enough, whereas a conditional budget margin is conditionally allocated to a designated lower priority task in addition to its budget. The higher priority task monitors its budget use and if the higher priority task determines its budget margin is unnecessary, the lower priority task is allowed to use its conditional budget margin.

According to one aspect of the present invention, a higher priority task (e.g., a More Important Task) voluntarily restraints its budget usage to a budget without margin, and then subsequently explicitly decides to use the margin when needed.

According to another aspect of the present invention, the higher priority task informs an Allocation Mechanism about the decision, and a lower priority task (e.g., a Less Important Task) is informed as well, either directly or indirectly. This enables the Allocation Mechanism or a scheduler to provide this unused budget margin to the lower priority task, at least until the higher priority task subsequently determines that it needs this budget margin. Other aspects of the present invention will become apparent to those of skill in the art upon a review of the detailed description in light of the following drawings.

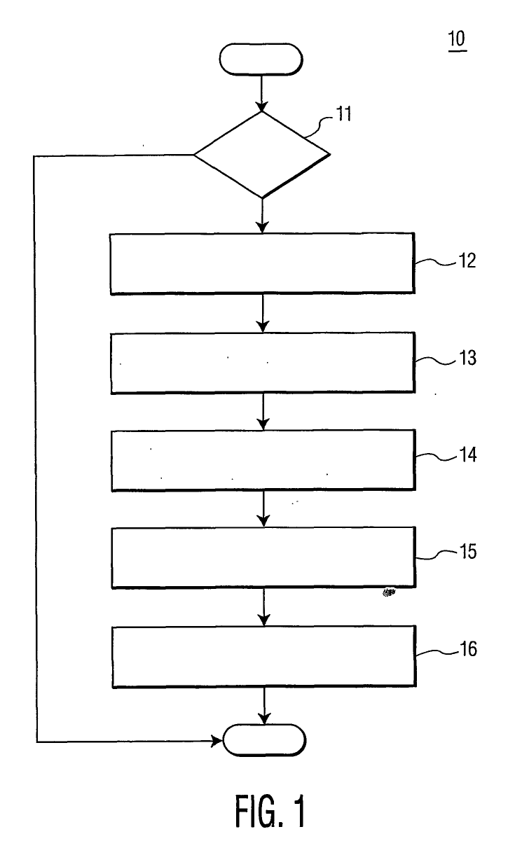

FIG. 1 depicts a task manager for controlling multiple tasks by assignment of relative priorities to the tasks.

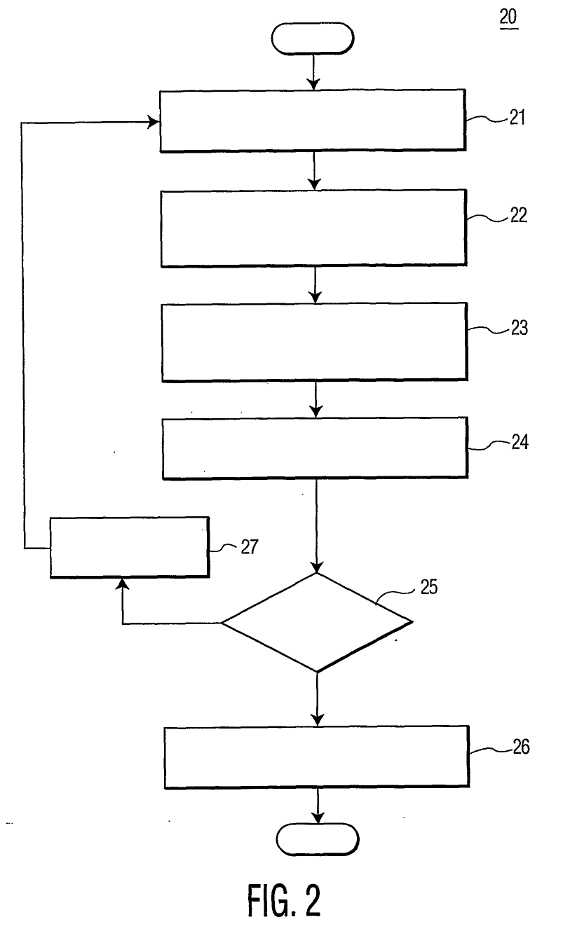

FIG. 2 depicts an allocation mechanism for controlling multiple tasks by allocation of resources to the various tasks.

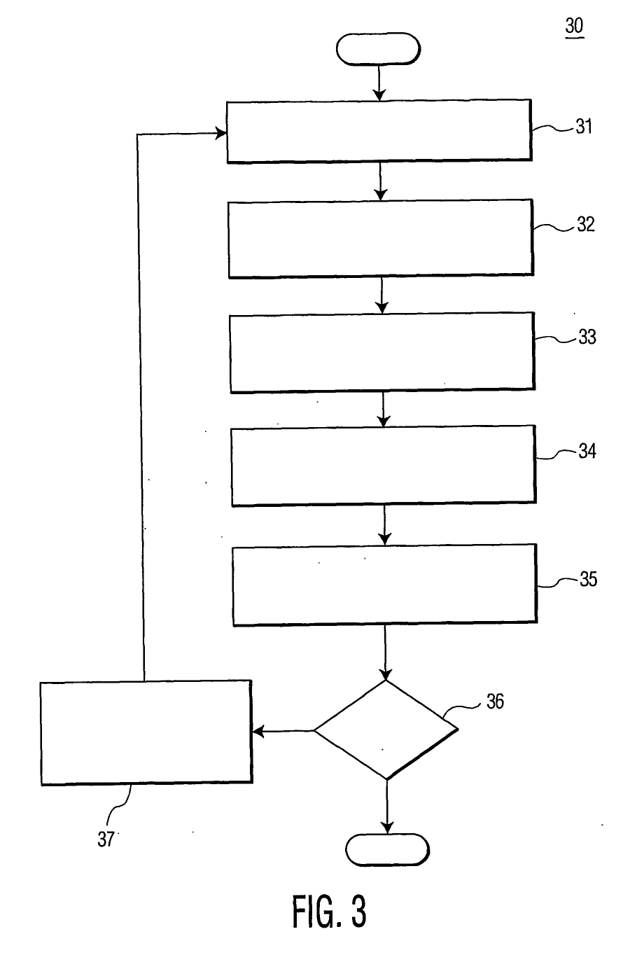

FIG. 3 depicts a scheduler for controlling multiple tasks by granting resources to the various tasks in accordance with their reservations.

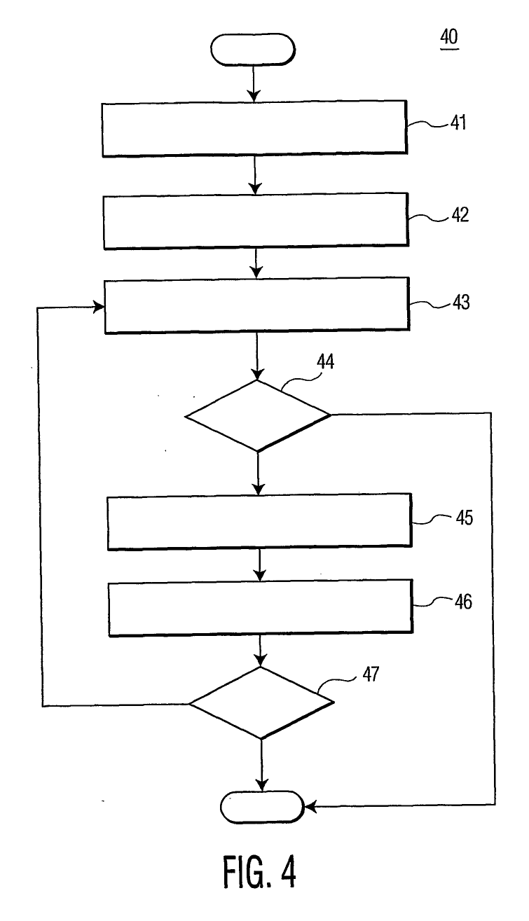

FIG. 4 depicts a more important task operating within its allocation of resources.

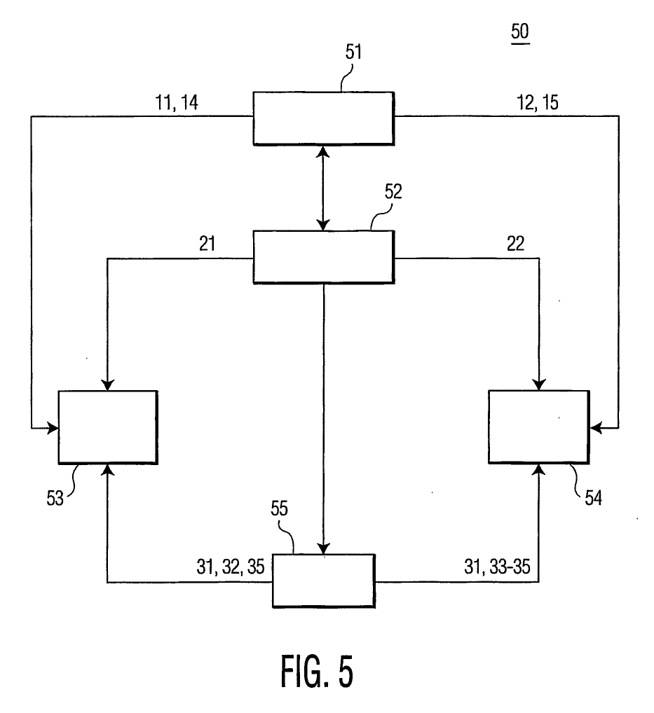

FIG. 5 depicts the interaction of the various elements of FIGS. 1-4 and 19.

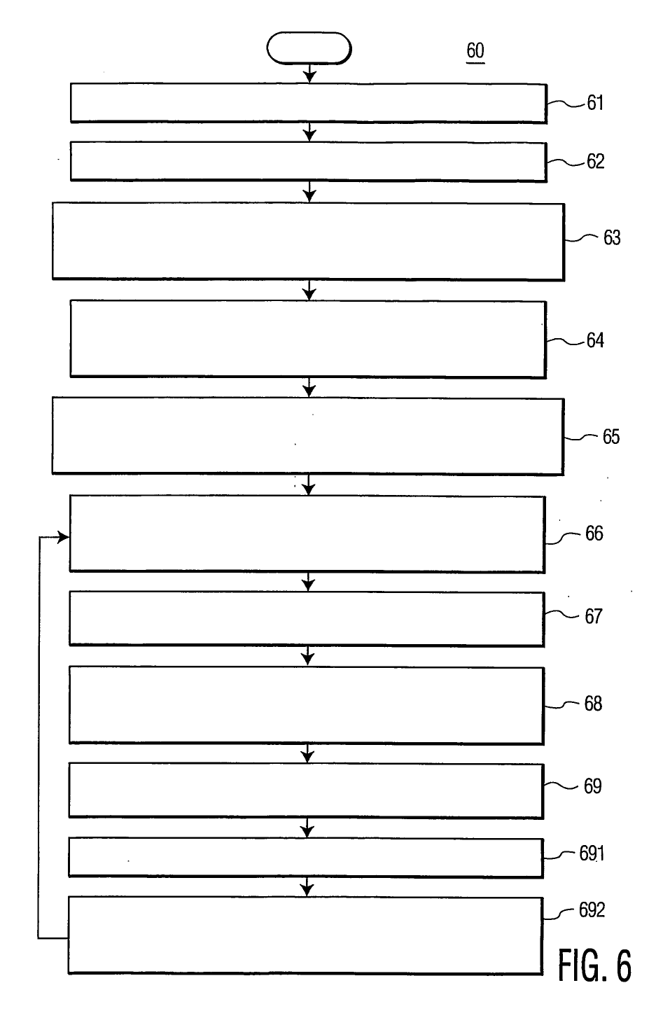

FIG. 6 depicts an exemplary embodiment of an operating system according to one aspect of the present invention.

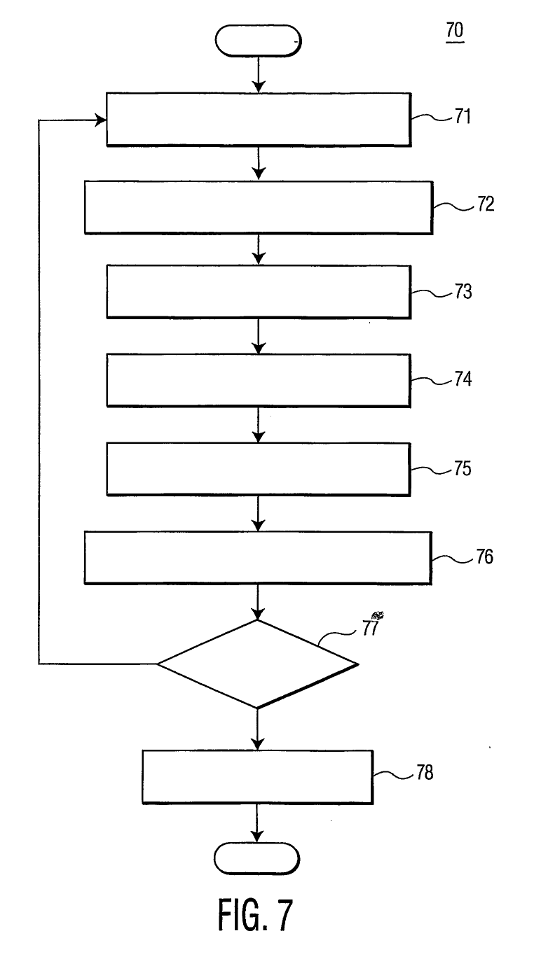

FIG. 7 depicts an exemplary embodiment of an allocation mechanism according to another aspect of the present invention.

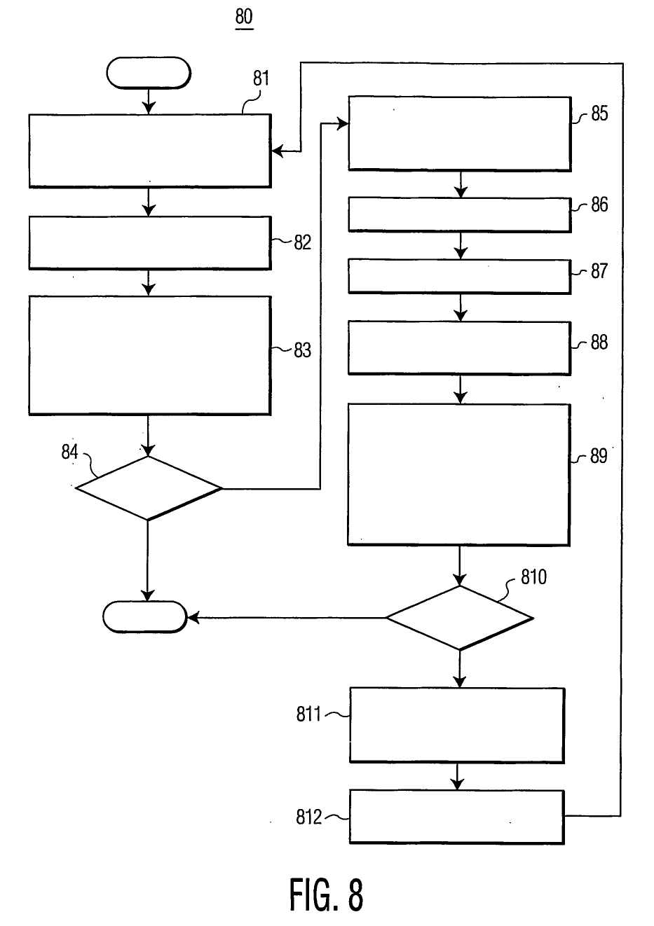

FIG. 8 depicts an exemplary embodiment of a scheduler according to yet another aspect of the present invention.

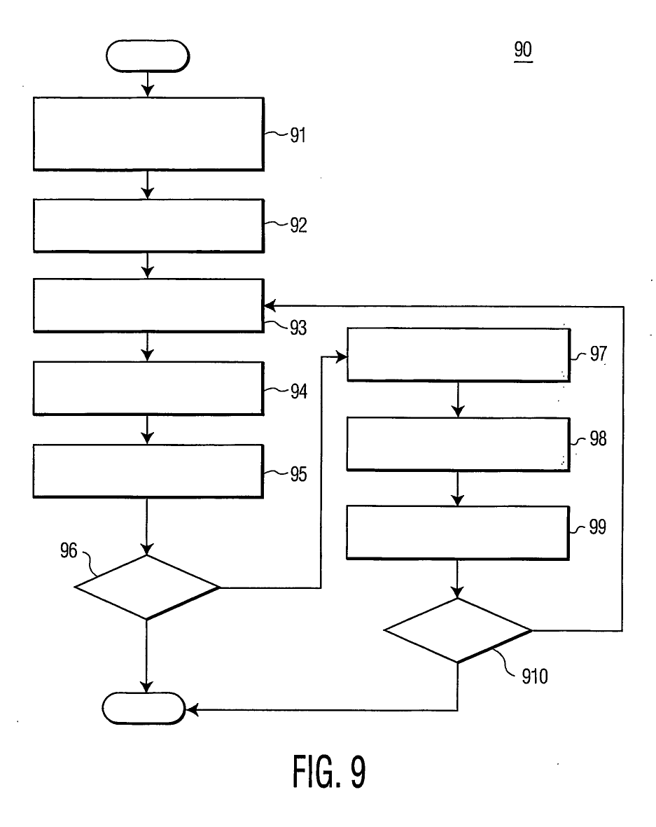

FIG. 9 depicts an exemplary embodiment of a more important task operating according to still another aspect of the present invention.

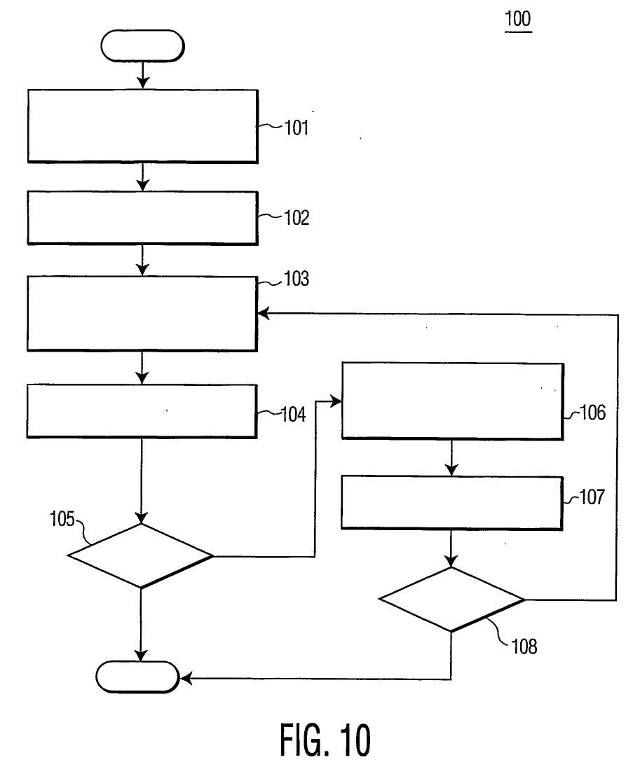

FIG. 10 depicts an exemplary embodiment of a less important task operating according to yet another aspect of the present invention.

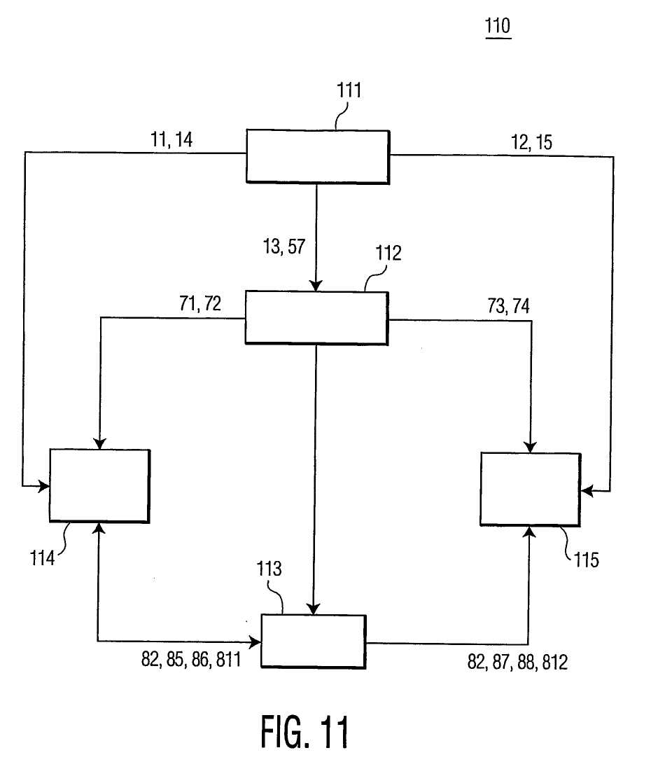

FIG. 11 depicts the interaction of the various elements of FIGS. 1 and 7-10 according to still another aspect of the present invention.

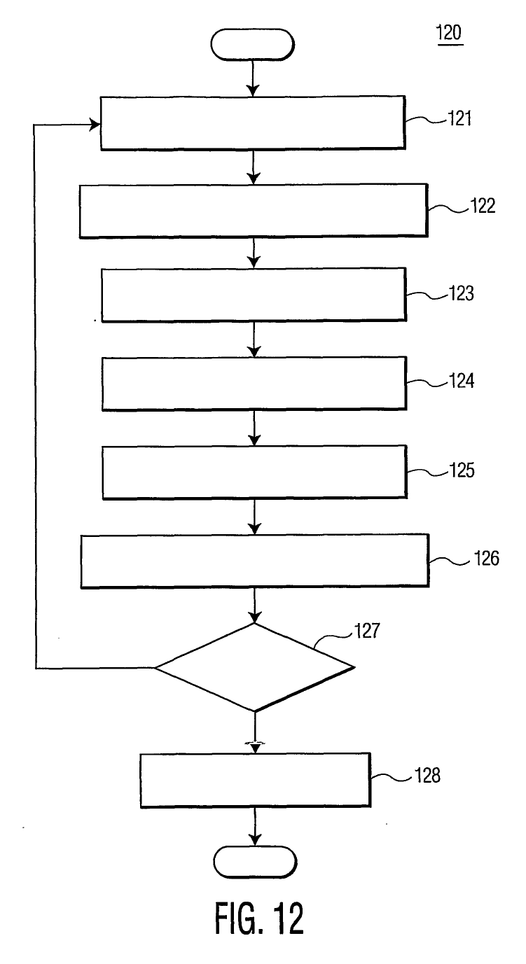

FIG. 12 depicts another exemplary embodiment of an allocation mechanism according to yet another aspect of the present invention.

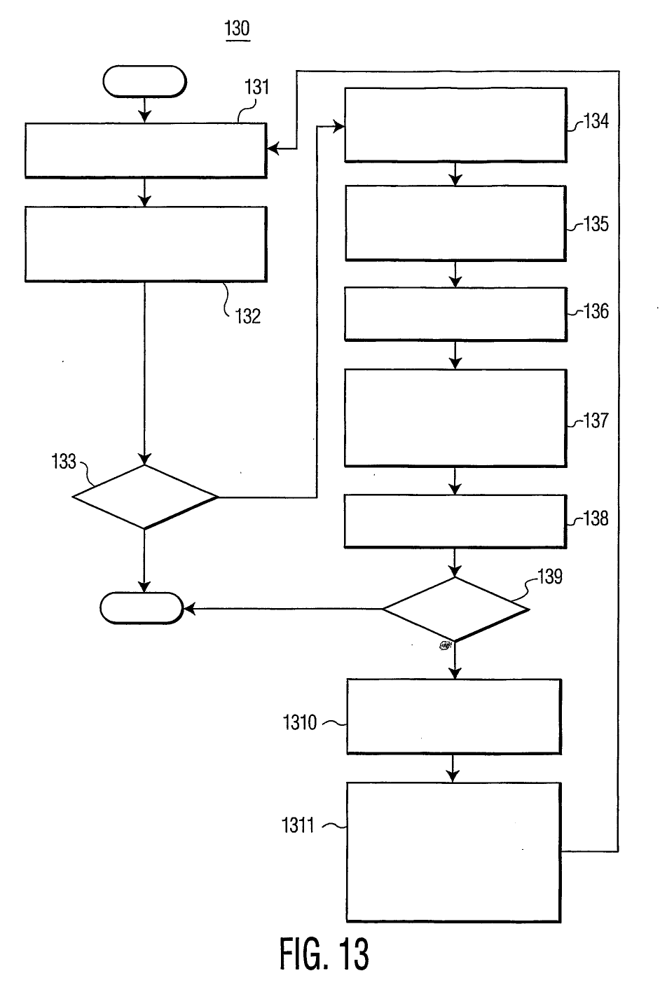

FIG. 13 depicts an exemplary embodiment of a conditional budget monitor according to still another aspect of the present invention.

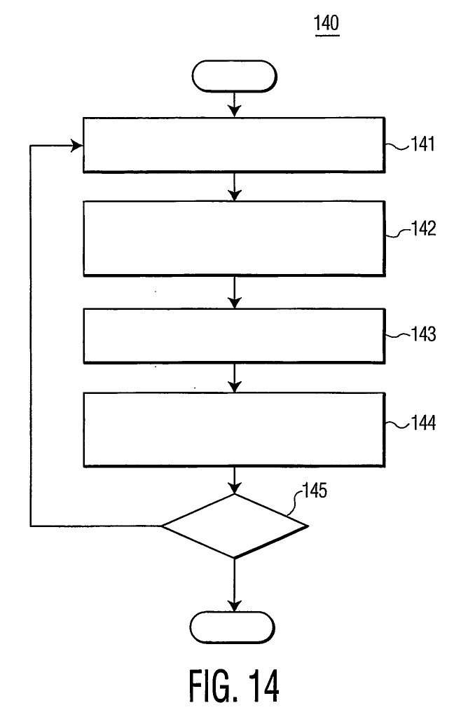

FIG. 14 depicts another exemplary embodiment of a scheduler according to yet another aspect of the present invention.

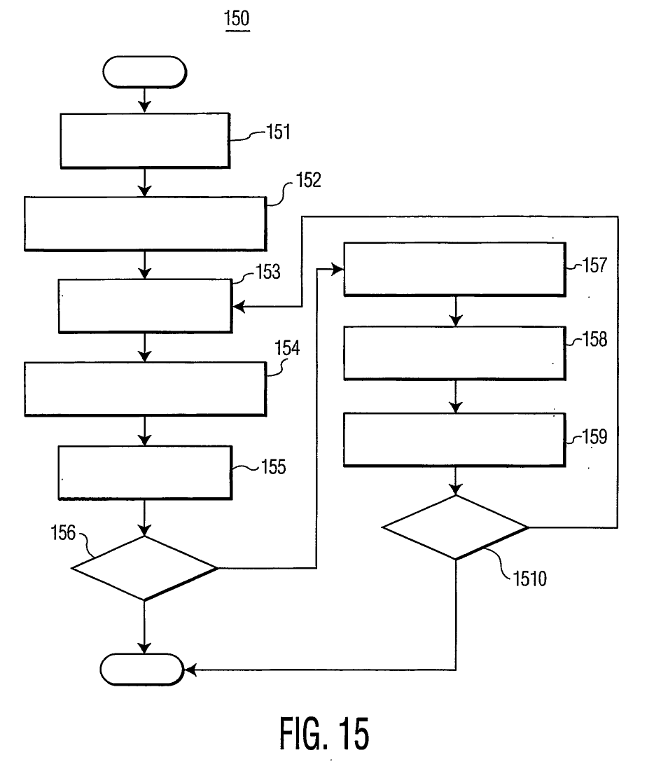

FIG. 15 depicts an additional exemplary embodiment of a more important task operating according to still another aspect of the present invention.

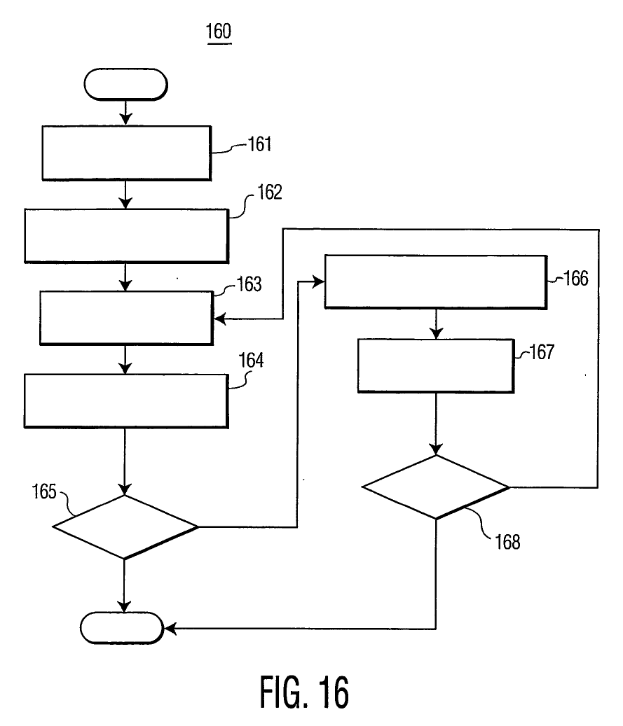

FIG. 16 depicts an additional exemplary embodiment of a more important task operating according to yet another aspect of the present invention.

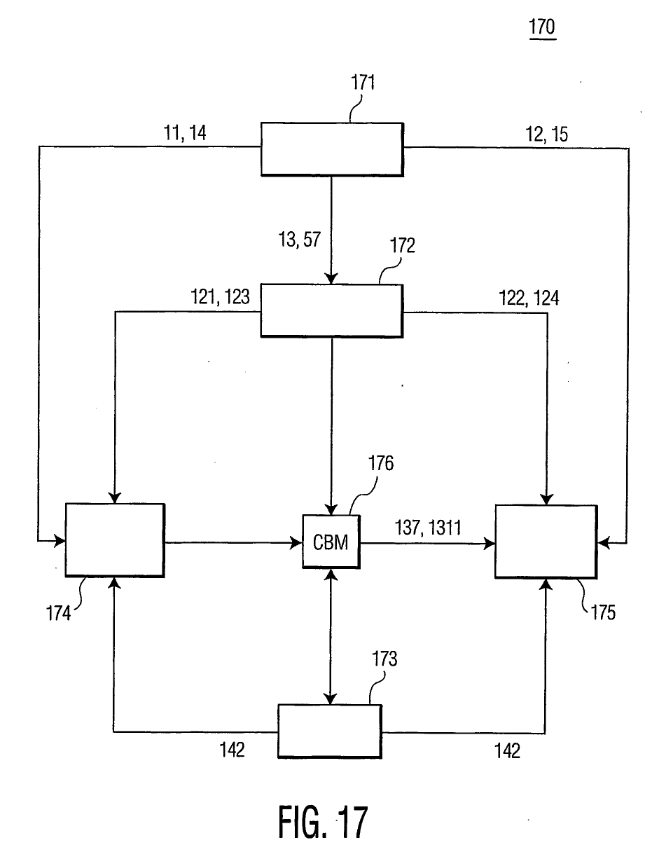

FIG. 17 depicts the interaction of the various elements of FIGS. 1 and 12-16 according to still another aspect of the present invention.

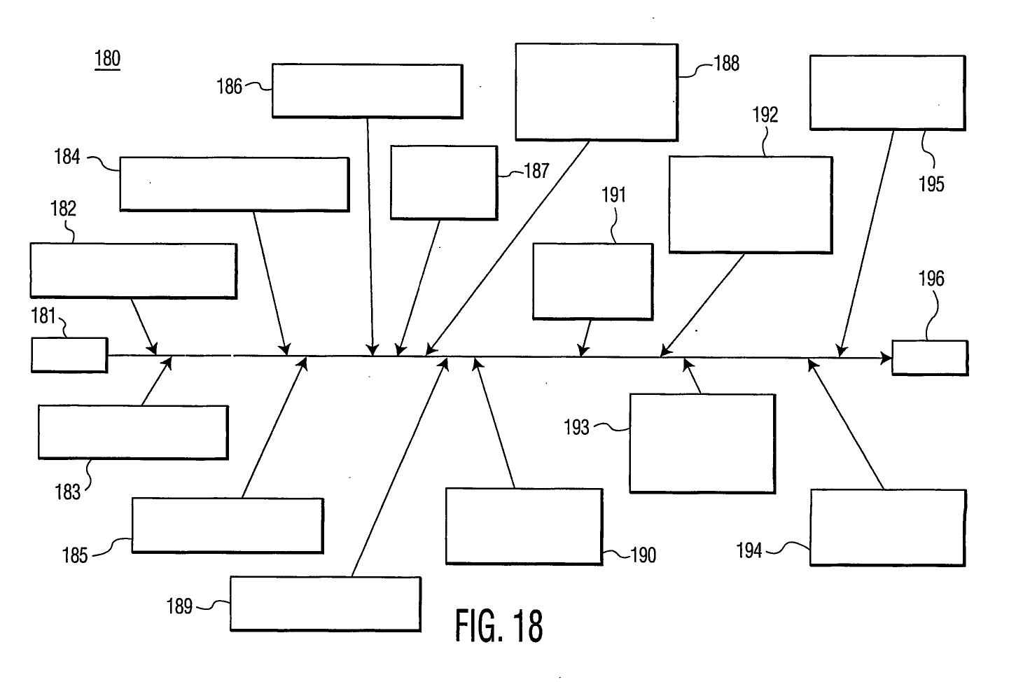

FIG. 18 depicts a time line of the interactions of the various processes according to yet another aspect of the present invention.

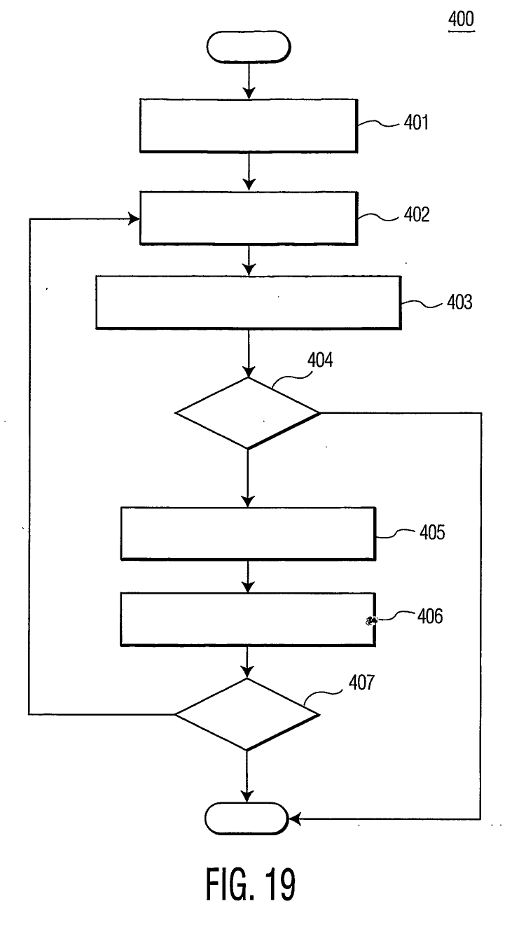

FIG. 19 depicts a less important task operating within its allocation of resources.

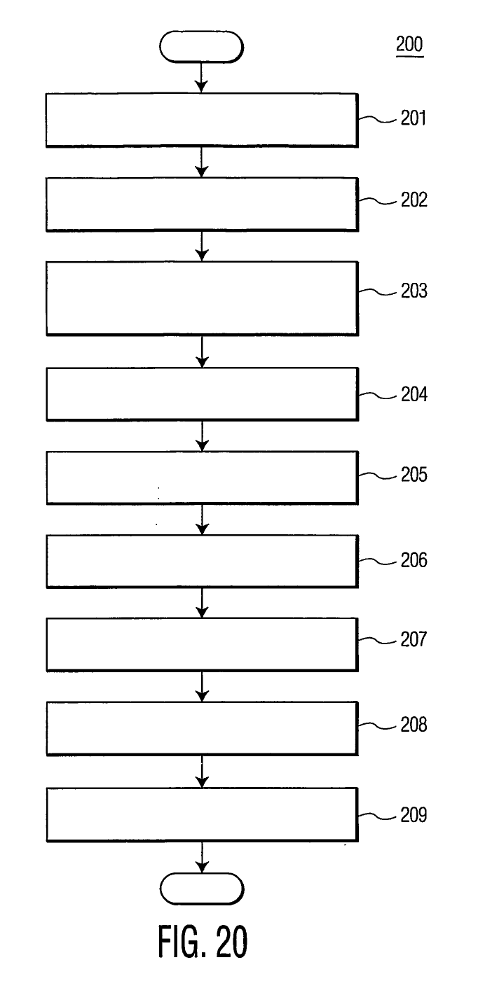

FIG. 20 depicts an exemplary embodiment of a synchronous process execution.

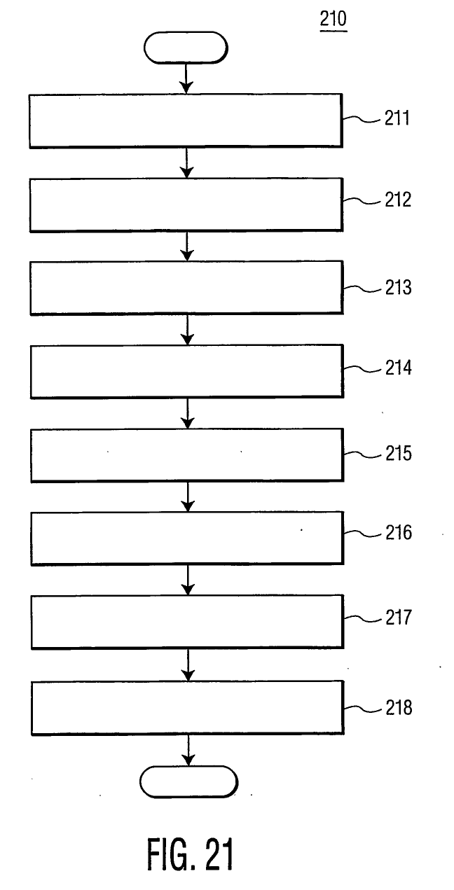

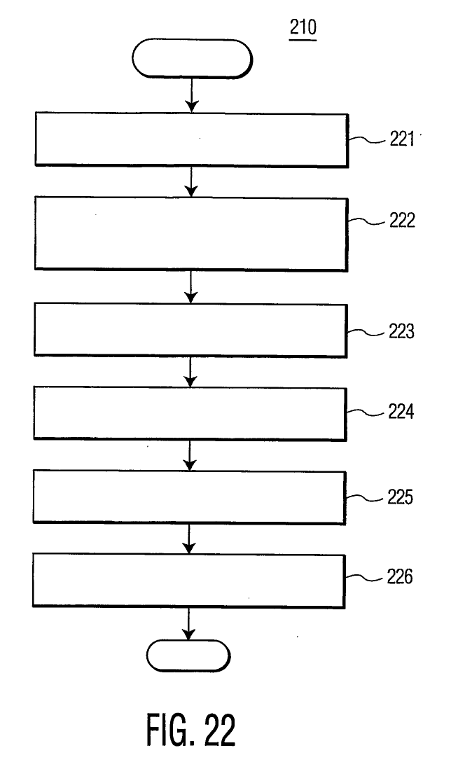

FIGS. 21-22 depict an exemplary embodiment of an asynchronous process execution.

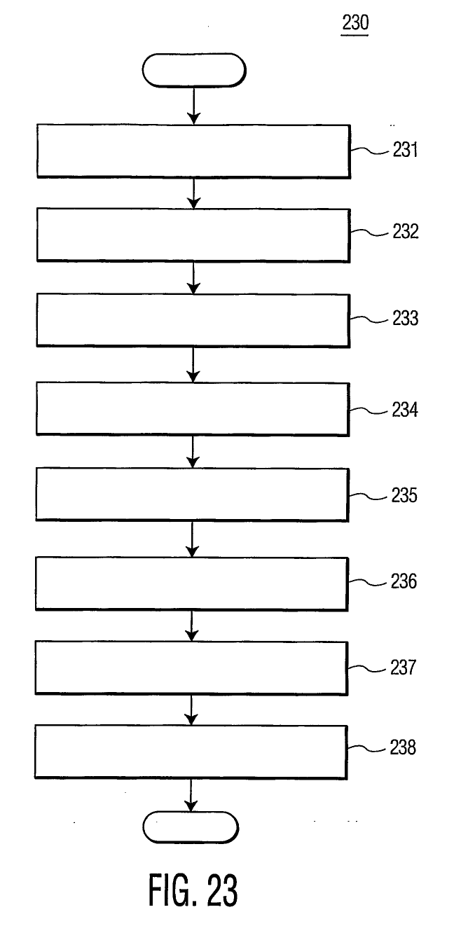

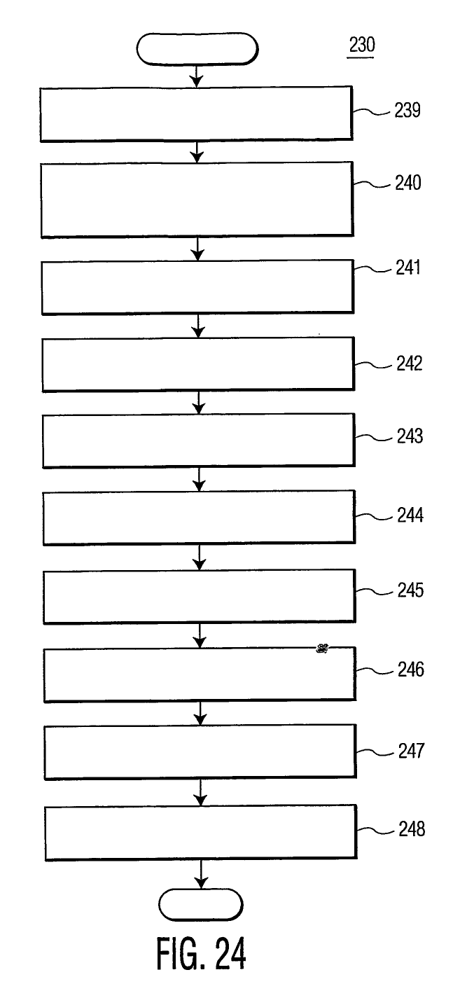

FIGS. 23-24 depict another exemplary embodiment of an asynchronous process execution.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Details regarding the assignment of priorities, designations of MITs and LITs, and the determination of budgets and other related information could be found in U.S. patent application Ser. Nos. 10/169,346 and 10/294530, both of which have been incorporated by reference as if repeated herein in their entirety including the drawings. It should be noted that in these patent applications, the notion of priority is being used in the meaning of Operating System priority, and not in the meaning of relative importance. In the scheduling algorithm used, the former priorities are in general allocated according to the budget periods. Sometimes it is convenient to unify the OS priorities and the relative importance, especially if all tasks have the same budget period. However, unifying the two priority types is not always applicable. Moreover, OS priorities may be dynamic, e.g. in an OS that uses earliest deadline first scheduling. In that case the two priority types cannot be unified. Therefore, the following shall focus on the aspects relating to the interaction of the MIT, the LIT, the Allocation Mechanism and the scheduler to make use of the Guaranteed Budget Margin when not being used by the MIT. FIGS. 1-5 depict the various elements to which the inventions set forth herein are applicable.

FIG. 1 shows an exemplary embodiment of a task manager process 10 for controlling two tasks in a real-time operating system. As used herein, task manager and application manager (see description of FIG. 5) may be used synonymously. A realistic task manager includes a cycle. This means that there exists a condition element (e.g., continue?—element 11) right after start. If yes, the process 10 performs elements 12 through 16 and loops back to the condition element 11 (while loop). If no, process 10 stops. According to process 10, one task is assigned to be a More Important Task 12, while a second task is assigned to be a Less Important Task 13. There may be more than one More Important—Less Important task pairs at any point in time, but the description herein refers to a single pair. What is described herein could be applicable to multiple pairs though. At this point in the process, the task manager (or some equivalent) becomes inactive (with respect to these two tasks) 14. Subsequently, the first task is de-assigned from being the More Important Task 15 and the second task is de-assigned from being the Less Important Task 16, and the process 10 ends.

Turning to FIG. 2, shown therein is an exemplary embodiment of an allocation mechanism process 20 (e.g., when active during element 14 of FIG. 1), with respect to the same two tasks. The allocation mechanism allocates a Guaranteed Budget Margin (GBM) to the MIT along with a More Important Guaranteed Budget (MIGB) 21. The allocation mechanism then allocates a Less Important Guaranteed Budget (LIGB), and conditionally allocates a Conditionally Guaranteed Budget Margin (CGBM), to the LIT 22. The allocation mechanism then sends a reservation command according to the allocations made 23. Next, the allocation mechanism does nothing until triggered by some event 24. If the event indicates to continue at decision element 25, the determination is made that the budgets are not adequate 26, and the allocation mechanism process 20, returns to element 21; otherwise, the MIT and LIT roles have expired 27, and the process ends.

It should be noted that in FIG. 2 (as well as FIGS. 7 and 12 discussed infra) it is assumed that the budgets are dynamically adjustable. The methods set forth herein also operate when budgets are NOT dynamically adjustable. In this case, FIG. 2 (and FIGS. 7 and 12, as well) would become much simpler because the allocation is done only once. In this case, elements 24, 25, 26 and 27 (and their counterparts in FIGS. 7 and 12) are not required.

In the embodiments herein, we assume that the allocated budgets will be replenished periodically, and that the periods and start times are determined by the task. Only the periodic budget is determined by the allocation mechanism. The use of such a periodic budget is as follows:

If task Y receives periodic budget B, with period T, and start time t₀, then at every instant t₀+n·T, with n≧0 the budget of Y is replenished to B units of time. Y is guaranteed to receive B units of time between t₀+n·T and t₀+(n+1)·T, for n≧0, if and only if it is able to consume these time units during that period. If it does not have enough work to consume the time units in the given period, the unused time is lost at t₀+(n+1)·T.

Note that a periodic budget is always related to a fractional budget (F), where F=B/T, and that the sum of all allocated fractional budgets must be smaller than or equal to 1. The embodiments herein do not exclusively apply for periodic budgets. In principle, the embodiments herein can be applied to all fractional budgets. The embodiments herein also do not exclusively apply to processors, CPUs, or operating systems; rather the embodiments can also be applied to other temporal resources (e.g., transportation bandwidth).

Turning to FIG. 3, shown therein is an exemplary embodiment of a scheduler process 30. The scheduler process includes a cycle very similar to the cycle of the allocation manager, i.e., the scheduler process includes an event 36 that leads to evaluating a condition element (continue?). If yes, there will be a new command from the allocation manager, and the scheduler cycles back to element 31. If no, the scheduler stops. Note that when the scheduler loops back, the scheduling algorithm 30 keeps running, which is indicated in FIG. 3 by element 37, which states: “Start the scheduling mechanism” (even when there are no tasks to schedule yet).

The scheduling process begins by accepting reservation commands from the allocation mechanism for the MIT and the LIT 31. The scheduler grants the MIGB and the GBM to the MIT, and thereby allows the scheduling mechanism to start providing them on a periodic basis, with a period that is typical for the MIT 32. The scheduler also grants the LIGB to the LIT and thereby allows the scheduling mechanism to start providing it on a periodic basis, with a period that is typical for the LIT 33. The scheduler conditionally grants the CGB to the LIT and thereby allows the scheduling mechanism to start providing it on a periodic basis, with a period that is typical for the LIT 34. The scheduling mechanism continues to run according to the current settings of the scheduling algorithm 35. In this way, the scheduling mechanism provides the granted budgets to the tasks. If an external event occurs 36, the scheduler reaches a condition 37. If the scheduler process 30 continues, the scheduler process loops back to element 31; otherwise the scheduling activity stops, and the scheduler terminates.

The “grant X to Y” is intended to mean “set the scheduling parameters in such a way that X is guaranteed to receive Y”. In contrast, “conditionally grants” means that, for example, the LIT “inherits” unused budget from MIT. The conditional provision is implicit; if the MIT leaves its full GBM unused, then the LIT gets its full CGBM.

Turning to FIG. 4, shown therein is an exemplary embodiment of a More Important Process interaction based on the embodiments in FIGS. 1-3. The MIT process begins using its MIGB and GBM 41. At some point, the MIT may no longer require the GBM 42. Thus, the MIT begins using only the MIGB 43. At decision point 44, the MIT continues or not. If the MIT continues, at some point the MIT may require the GBM 45. Thus, the MIT begins using the MIGB and the GBM 46. At decision point 47, the MIT process ends or continues at element 42.

Turning to FIG. 19, shown therein is an exemplary embodiment of a Less Important Process 400 interaction based on the embodiments in FIGS. 1-3. The LIT process begins using its LIGB 401. At some point, the CGBM becomes available 402. Thus, the LIT begins using the LIGB and the CGBM 4a3. At decision point 404, the LIT continues or not. If the LIT continues, at some point the CGBM will no longer be available 405. Thus, the LIT begins using the LIGB only 406. At decision point 407, the LIT process ends or continues at element 402.

Turning to FIG. 5, shown therein is an exemplary embodiment 50 of the interaction of the elements of FIGS. 1-4 and 19. An application manager 51 assigns and de-assigns the MIT role to a given task (elements 11 and 14 of FIG. 1). The application manager 51 also assigns and de-assigns the LIT role to another given task (elements 12 and 15). The application manager 51 then becomes inactive while the allocation mechanism 52 becomes active (element 13). When the MIT and LIT roles expire (element 26 of FIG. 2), the application manager 51 becomes active again, while the allocation mechanism 52 becomes inactive. The allocation mechanism 52 allocates the MIGB and the GBM to the MIT (element 21 of FIG. 2) and the LIGB and the CGBM to the LIT (element 22 of FIG. 2). The allocation mechanism 52 sends the reservation to the scheduler 55 (element 23 of FIG. 2), which activates element 31 of FIG. 3, in which the scheduler 55 accepts reservation commands for the LIT and the MIT from the allocation mechanism (element 31), grants the MIGB and GBM to the MIT 53 and the scheduling mechanism starts providing them on a periodic basis to the MIT (element 32). The scheduler 55 also grants the LIGB to the LIT 54 and begins providing this on a periodic basis to the LIT (element 33). The scheduler 55 also conditionally grants the CGBM to the LIT 54, and starts providing this to the LIT 54 on a conditional basis (element 34). The scheduler 55 then runs in accordance with a scheduling algorithm (element 35). During this time, the MIT at some point does not require the GBM 42, and the CGBM becomes available to the LIT 400. At some other point, the MIT requires the GBM again 45, and the CGBM is no longer available to the LIT 4a5. This sequence of 42-4a2 followed by 45-4a5 can be repeated one or more times. In the case of zero repetitions, which is realistic, FIGS. 4 and 19 would need to be modified, with the condition element 47 between elements 41 and 42 rather than between elements 46 and 42, thereby implying a while loop instead of an until loop.

A More Important Task (FIG. 4) can have two types of behavior. The first type of behavior, known as synchronous behavior, occurs when the task works in synchrony with the budget consumption (i.e., the task starts when the budget is replenished and completes its work within the budget period).

Turning to FIG. 20, shown therein is an exemplary embodiment of a timeline 200 for a synchronous task. At the start of a first budget period 201, with replenished MIGB and. GBM, the corresponding execution of the task (e.g., processing of a first video frame) starts 202. Some time later, the task execution completes 203. The MIGB is not completely used up, and the GBM is completely unused. Some time later, the first period terminates 204.

At the start of a second budget period 205, with replenished MIGB and GBM, the corresponding execution of the task (e.g., processing of the first video frame) starts 206. Some time later, the MIGB is completely depleted 207. Still some time later, the task execution completes 208. The GBM is not completely used up. Yet some time later, the second budget period terminates 209.

The timeline shows two exemplary budget periods. In the first budget period, from 201 to 204, the task execution completes within the MIGB. In the second budget period from 205 to 209, task execution also requires some part of the GBM.

The second type of behavior, known as asynchronous behavior, occurs when the task does not work in synchrony with its budget. In asynchronous behavior, a task may work-ahead or lag-behind its budget consumption. Asynchronous behavior is often used to smoothen out loads. Turning to FIG. 21, shown therein is an exemplary embodiment of a timeline 210 for an asynchronous task. At the start of a first budget period 211, with replenished MIGB and GBM, the first execution of the task (e.g., processing of the first video frame) starts 212. Some time later, the MIGB is fully depleted 213. Still some time later, the first task execution completes in time, while the GBM is not completely used up 214. The task immediately starts its second execution 215. Still some time later, the GBM is also depleted 216, and the second task execution is suspended 217. Yet some time later, the period terminates 218. During this first budget period, one task completion has taken place. In other words, the task has completed one unit of work.

At the start of a second budget period 221, with replenished MIGB and GBM, the second task execution, suspended in the previous period, is resumed 222. Some time later, the MIGB is completely depleted 223. Still some time later, the GBM,is also depleted 224, and the second task execution is again suspended 225. Some time later, the period terminates 226. During this second period, no task completion has taken place. The second task execution will be late. Turning to FIG. 23, shown therein is another exemplary embodiment of a timeline 230 for an asynchronous task. At the start of the first budget period 231, with replenished MIGB and GBM, the first task execution starts 232. Some time later, the first task execution completes in time 233. The task immediately starts its second execution 234. Still some time later, while the MIGB is completely used up 235, and after that the GBM is also depleted 236. At this point the second task execution is suspended 237. Some time later, the period terminates 238. During this first period one task execution is completed.

At the start of a second budget period 239, with replenished MIGB and GBM, the task execution suspended in the previous period is resumed 240. Some time later, the second task execution completes 241, and the third task execution gets started 242. Still some time later, the MIGB is completely depleted 243. Still some time later, the third task execution completes early 244. The fourth task execution starts 245. Some time later, the GBM is also depleted 246, and hence the fourth task execution is suspended 247. Still some time later, the period terminates 248. In this second period, two task executions completed.

The two timelines 210 and 230 show that the situation can be very different depending on the budget period, but that a short task execution does not necessarily free up the GBM when the task executes asynchronously.

According to one aspect of the present invention, the provision of a Conditionally Guaranteed Budget Margin (e.g., an amount of resources allocated to a task that is above and beyond the amount budgeted for the task, which is not necessarily guaranteed to be available for every budget period, but rather its availability is dependent on some other factor) is implicit. In contrast, the allocation is always explicit. The per-period provision is implicit. According to another aspect of the present invention, if the More Important Task (MET) does not use its Guaranteed Budget Margin, the Less Important Task receives the MITs Guaranteed Budget Margin. This can lead to the following problem. Even though the More Important Guaranteed Budget (MIGB) is on average sufficient for the MIT, the budget consumption of the MIT may still exceed the More Important Guaranteed Budget during certain budget periods (such as during transient high loads for synchronous tasks, 207-208, and when a next task execution is ready to start for asynchronous tasks 213 and 243). In these periods, the MIT will use part of its Guaranteed Budget Margin, and the LIT will receive less than its Conditionally Guaranteed Budget Margin.

There is a second related problem, which occurs with asynchronous processing only. An asynchronous task is unable to restrain its budget use, precisely because it is asynchronous. Load Estimation and load adjustment

MITs with synchronous behavior are sometimes able to estimate the amount of work to be done before doing the work, and subsequently process the data in such a way (i.e., at such a quality level) that the work is completed before the budget is fully depleted. MITs with asynchronous behavior typically measure the amount of progress made, and subsequently adjust the quality level of processing data to avoid missing deadlines. In both cases, the MIT keeps track of how well the budgets fit its needs. This capability can be used to request the allocation manager to adjust the budgets.

In general, to the above elements and functions, the present invention employs inter alia conditionally guaranteed budget margins (CGBMs) associated with tasks assigned relative importance.

According to one aspect of the present invention, the MIT and the LIT are explicitly informed of their budgets. Thus, the MIT can therefore restrain its budget usage to the budget without margin.

According to another aspect of the present invention a More Important Task (MIT) voluntarily restraints its budget usage to a budget without margin, and explicitly decides to use or not use the margin when needed. The More Important Task informs its environment (e.g., the allocation mechanism or the scheduler or a budget monitor) about the decision. The Less Important Task (LIT) gets informed that it will or will not receive its CGBM (either directly from the MIT or indirectly through another agent). This decision is not necessarily intended to be made on a per-budget basis, but usually much less frequently. Moreover, the decision is not always made at a budget boundary either. This decision is typically made at the start of a new task execution. Restraining the budget use is not sufficient. An asynchronous task is unable to stop executing when the MIGB is depleted, and the GBM is still available. An asynchronous task is unable to detect this transition. Therefore, a second aspect of the present invention is that while the MIT initiates the budget restriction, the scheduler actually performs it by constraining the MIT to its MIGB.

Turning to FIG. 6, shown therein is an exemplary embodiment of a method 60 for controlling multiple tasks in a real-time operating system according to one aspect of the present invention. In the method 60, a first task is assigned to be a More Important Task (element 61). The prioritization of this task enables the system to allocate resources or other limited availability items, such as processor access, memory, user interfaces, etc.

A second task is assigned to be a Less Important Task (element 62). The second task is merely a task that is considered to be a lower priority (i.e, lower relative importance) than the first task, however, the second task may also be a higher priority (i.e., higher relative importance) task than some other task or tasks.

A Guaranteed Budget Margin is then allocated to the More Important Task along with a More Important Guaranteed Budget, and The MIT is informed of that allocation (element 63). A More Important Guaranteed Budget is the amount of resources or other limited availability items set aside for use by the first task. The Guaranteed Budget Margin is the amount of resources or other limited availability items set aside for use by the first task above and beyond the More Important Guaranteed Budget in case needed by the first task.

A Less Important Guaranteed Budget is also allocated to the Less Important Task and the LIT is informed of that allocation (element 64). The Less Important Guaranteed Budget is the amount of resources or other limited availability items set aside for use by the second lower priority task. In addition, a Conditionally Guaranteed Budget Margin is conditionally allocated to the second task, which is informed of that allocation (element 65).

At some point during execution, the higher priority or More Important Task may determine that the More Important Task no longer requires the Guaranteed Budget Margin in the subsequent budget periods (element 66). This can occur because the higher priority task monitors its usage of budget items, and can predict its needs during a given budget cycle. A message is then sent that the More Important Task does not require its Guaranteed Budget Margin (element 67). This message can originate with the MIT or from some other process, such as a scheduler or a conditional budget monitor. However, the only one that can send this message is the one that detects that the GBM is no longer needed. The most likely candidate for sending this message is the MIT. In case of a synchronous MIT, it could be the scheduler. In the embodiments presented here, the MIT is the one that detects the fact and sends the message. If another party does this, the MIT has to be informed as well.

If the higher priority or More Important Task or some other task indicates that the MIT does not require the Guaranteed Budget Margin, the conditionally allocated Conditionally Guaranteed Budget Margin can then be provided to the Less Important Task (element 68). The Conditionally Guaranteed Budget Margin is the amount of resources or other limited availability items set aside for use by the second task above and beyond the Less Important Guaranteed Budget in case needed by the second task, but which amount is only provided when not needed elsewhere, such as by the higher priority or More Important Task.

Once the message is sent, it is important that the More Important Task really does not use its GBM, in whole or in part, during all budget cycles, in order to guarantee the CGBM to the second task in every budget cycle, until CGBM is explicitly withdrawn.

At some other point during execution, the higher priority or More Important Task may determine that the More Important Task again requires the Guaranteed Budget Margin in the subsequent budget cycles (element 69). A message is then sent that the More Important Task does require its Guaranteed Budget Margin (element 691). If the higher priority or More Important Task indicates that it does require its Guaranteed Budget Margin, the conditionally allocated Conditionally Guaranteed Budget Margin can no longer be provided to the Less Important Task, hence the CGBM is removed from the LIT and the GBM is provided to the MIT and the MIT and LIT are informed of these allocations (element 692). This process of requiring and not requiring the GBM can be repeated several times, as indicated by the loop. In the embodiments herein, the control algorithm local to the higher priority task (e.g., the MIT) is extended in such a way that the control algorithm:
(a) restrains the MIT's budget usage voluntarily, if appropriate (part of element 66 in FIG. 6);
(b) signals that the Guaranteed Budget Margin (GBM) is required from now on, or that the Guaranteed Budget Margin is no longer required from now on (see element 67, FIG. 6). As used herein, the budget of the higher priority task relates to the amount of resources or other limited availability items set aside for use by the higher priority task. Also, as used herein, the Guaranteed Budget Margin refers to the budgeted amount of resources (or other limited availability items) above that already allocated to the higher priority task, which is set aside for the higher priority task.

An MIT with synchronous behavior will be able to restrain itself during every budget period so that the Guaranteed Budget Margin is automatically provided to the lower priority task (e.g., the Less Important Task) (see elements 201-204, FIG. 20). An MIT with asynchronous behavior cannot do so precisely because its behavior is asynchronous with respect to the budget period (as shown in FIGS. 21-24). Without explicit help of the scheduler, an asynchronous MIT will keep consuming its budget (e.g., the More Important Guaranteed Budget) along with its budget margin (e.g., the Guaranteed Budget Margin) until the asynchronous MIT blocks for lack of input, being increasingly ahead with respect to the budget period, as indicated in FIGS. 21-22 and 23-24. In case of an asynchronous MIT (see FIGS. 21-24), which is the more general case, a second aspect of the invention is therefore required to ensure the desired budget transfer in two directions.

In case the tasks can operate asynchronously, at run time, with the modified control algorithm in place, the following, modified budget allocation protocol ensures the desired budget transfer in two directions.

A: When the budgets are assigned by the allocation mechanism:

1. The allocation mechanism explicitly informs the MIT about its More Important Guaranteed Budget and Guaranteed Budget Margin (see element 63, FIG. 6);

2. The allocation mechanism explicitly informs the Less Important Task about its Less Important Guaranteed Budget and Conditionally Guaranteed Budget Margin (see element 64, FIG. 6);

3. The scheduler provides the More Important Guaranteed Budget+Guaranteed Budget Margin to the MIT at the first possible occasion (see element 63, FIG. 6);

4. The scheduler provides the Less Important Guaranteed Budget to the LIT at the first possible occasion (see element 68, FIG. 6).

B: When the MIT does not require its budget margin:

1. At some point during execution, the MIT observes that it can do its job with its More Important Guaranteed Budget only (see element 66, FIG. 6);

2. The MIT explicitly informs the scheduler that it does not require its Guaranteed Budget Margin (see element 67, FIG. 6);

3. The scheduler stops providing the Guaranteed Budget Margin to the MIT at the first possible occasion (part of element 67, FIG. 6);

4. The scheduler starts providing the Conditionally Guaranteed Budget Margin to the LIT at the first possible occasion, which may or may not be instantaneous; depending on the application (see element 68);

5. The scheduler informs the LIT of this additional budget provision (element 68).

C: When MIT requires its budget margin again:

1. At some point during execution, the MIT observes that it requires its Guaranteed Budget Margin as well (element 69);

2. The MIT explicitly informs the scheduler that it does require its Guaranteed Budget Margin (element 691);

3. The scheduler informs the LIT that Conditionally Guaranteed Budget Margin will be withdrawn (element 692);

4. The scheduler stops providing the Conditionally Guaranteed Budget Margin to the LIT at the first possible occasion (part of element 692);

5. The scheduler starts providing the Guaranteed Budget Margin to the MIT at the first possible occasion (part of element 692).

Note that the LIT is informed of a budget decrease before the decrease takes place. The LIT is informed of a budget increase after the increase has taken place. The LIT cannot influence the change in any way.

FIG. 11 shows an exemplary embodiment of the roles and the interactions of the various processes described in FIGS. 7-10. A first task 114 has a first priority level, which first task 114 is called a higher priority task or a More Important Task. This higher priority task 114 can include either a task external to the operating system 110 or internal to the operating system 110.

A second task 115 has a second priority level lower than the first priority level. This lower priority task (or Less Important Task) 115 can include either a task external to the operating system 110 or internal to the operating system 110. Moreover, the second task 115 is merely lower in priority than the first task 114, but could even be the second most important task to be executed. In these two paragraphs all priorities are relative importance.

An allocation mechanism 112 is included to allocate budgets of resources among the various tasks 114, 115 to be performed by the operating system 110. According to one aspect of the present invention, the allocation mechanism 112 explicitly informs the first task 114 about a More Important Guaranteed Budget and a Guaranteed Budget Margin. The. More Important Guaranteed Budget is the amount of resources or other limited availability items set aside for use by the first task 114. The Guaranteed Budget Margin is the amount of resources or other limited availability items set aside for use by the first task 114 above and beyond the More Important Guaranteed Budget in case needed by the first task 114. The allocation mechanism 112 also explicitly informs the second task 115 about a Less Important Guaranteed Budget and a Conditionally Guaranteed Budget Margin. The Less Important Guaranteed Budget is the amount of resources or other limited availability items set aside for use by the second or lower priority task 115.

A scheduler 113 controls provisioning of the budgeted amounts of resources to the various tasks 114, 115 to be performed by the operating system 110, including the first task 114 and the second task 115. The scheduler 113 provides the More Important Guaranteed Budget plus the Guaranteed Budget Margin to the first task 114 at a first possible occasion. The scheduler also provides the Less Important Guaranteed Budget to the second task 115 at a first possible occasion.

If the first task 114 determines at some point during execution that the first task 114 can execute properly with the More Important Guaranteed Budget only, the first task 114 explicitly informs the scheduler 113 that the first task 114 does not require its Guaranteed Budget Margin. In this case, the scheduler 113 stops providing the Guaranteed Budget Margin to the first task 114 at a first possible occasion and starts providing the Conditionally Guaranteed Budget Margin to the second task 115 at a first possible occasion. After this, the scheduler 112 informs the second task 115 of the granting of the Conditionally Guaranteed Budget Margin.

The Conditionally Guaranteed Budget Margin is the amount of resources or other limited availability items set aside for use by the second task 115 above and beyond the Less Important Guaranteed Budget in case needed by the second task 115, but which amount is only provided when not needed elsewhere, such as by the higher priority or More Important Task 114.

Subsequently, the first task 114 may determine at some point during execution that the first task 114 requires the Guaranteed Budget Margin as well, in which case the first task 114 explicitly informs the scheduler 113 that the first task 114 does require its Guaranteed Budget Margin. The scheduler 113 then informs the second task 1 15 that the Conditionally Guaranteed Budget Margin will be withdrawn, the scheduler 113 stops providing the Conditionally Guaranteed Budget Margin to the second task 113 at a first possible occasion and the scheduler 113 starts providing the Guaranteed Budget Margin to the first task 114 at a first possible occasion.

An application manager 111 assigns and de-assigns the MIT role to a given task (elements 11 and 14 of FIG. 1). The application manager also assigns and de-assigns the LIT role to another given task (elements 12 and 15). The application manager 111 then becomes inactive while the allocation mechanism 112 becomes active (element 13 of FIG. 1). When the MIT and LIT roles expire (element 26 of FIG. 2), the application manager 111 becomes active again, while the allocation mechanism 112 becomes inactive. The allocation mechanism 112 allocates the MIGB and the GBM to the MIT (element 71 of FIG. 7) and explicitly informs the MIT of these allocations (element 72). The allocation mechanism 112 also allocates the LIGB and the CGBM to the LIT (element 73 of FIG. 7) and explicitly informs the LIT of these allocations (element 74 of FIG. 7). The allocation mechanism 112 sends the reservation to the scheduler 113 (element 75 of FIG. 7), which activates the scheduler process 80 of FIG. 8, which executes to completion. The scheduler 113 accepts reservation commands for the LIT and the MIT from the allocation mechanism (element 81); grants the MIGB and GBM to the MIT; and also grants the LIGB to the LIT (element 82). The scheduler then runs in accordance with a scheduling algorithm (element 83). The scheduler 113 receives a message from the MIT that the MIT no longer requires the GBM (element 85). The scheduler then grants only the MIGB to the MIT (element 86), informs the LIT of the budget increase (element 87), and grants the LIGB and the CGBM to the LIT (element 88). The scheduler 113 may subsequently receive a message from the MIT that the MIT now requires its GBM (element 811), in which case the scheduler 113 informs the LIT of the budget decrease (element 812).

Turning to FIG. 7, shown therein is an exemplary embodiment of an allocation mechanism process 70 according to another aspect of the present invention. The allocation mechanism process 70 allocates an MIGB and a GBM to the MIT 71. The allocation mechanism process 70 also allocates an LIGB and conditionally allocates a CGBM to the LIT 72. The allocation mechanism process 70 explicitly informs the MIT of its allocations 73. The allocation mechanism process 70 also explicitly informs the LIT of its allocations 74. The allocation mechanism process 70 sends a command reservation in accordance with the allocations to the MIT and LIT 75. The allocation mechanism process 70 then waits until it is triggered by some event 76. If the budgets are inadequate, the allocation mechanism process returns to element 71. If the budgets are adequate, the MIT and LIT roles expire 78, and the allocation mechanism process 70 ends.

FIG. 8 shows an exemplary embodiment of a scheduler process 80 according to another aspect of the present invention. The scheduler process 80 receives the reservation commands (as indicated by element 75 of FIG. 7) 81, and grants the MIGB and the GBM to the MIT and the LIGB to the LIT 82. The scheduling process 80 then executes in accordance with the scheduling algorithm 83. At decision point 84, the process 80 continues or ends. If the scheduling process 80 continues, at some point the scheduling process may receive a message from the MIT indicating the MIT no longer requires its GBM 85. The scheduler then grants the MIGB only to the MIT (or removes the GBM from the MIT so the MIT has only the MICG) 86. The scheduler process 80 then grants the LIGB and the CGBM to the LIT (or adds the CGBM to the LIT's resources) 87. The scheduler process 80 then informs the LIT of the budget increase 88. The scheduling process 80 then executes in accordance with the scheduling algorithm 89. At decision point 810, the scheduling process 80 continues or ends. If the scheduling process 80 continues, at some point the scheduling process 80 may receive a message from the MIT indicating the MIT now requires its GBM 811. The LIT is informed of the budget decrease from the scheduler 812 and the scheduling process 80 returns to element 81.

Turning to FIG. 9, shown therein is an exemplary embodiment 90 of the interaction of the MIT process with the various other tasks. The MIT process 90 is informed by the allocation mechanism process 70 of the MIGB and the GBM 91. The MIT process 90 begins using the MIGB and the GBM with the scheduler 92. The MIT process 90 determines that it does not require the GBM 93, and informs the scheduler process 80 that the GBM is not required 94. The MIT process 90 then begins using the MIGB only 95. At decision point 96, the MIT process 90 either continues or ends. If the MIT process 90 continues, the MIT process 90 may determine that it now requires its GBM 97. The MIT process 90 informs the scheduler process 80 that it now requires the GBM 98, and the MIT process 90 begins using the MIGB and the GBM with the scheduler process 99. At decision point 910, the MIT process 90 either ends or returns to element 93.

Turning to FIG. 10, shown therein is an exemplary embodiment 100 of the interaction of the LIT process with the various other tasks. The LIT process 100 is informed by the allocation mechanism process 70 of the LIGB and the CGBM 101. The LIT process 100 begins using the LIGB with the scheduler 102. At some point the LIT process 100 may be informed by the scheduler process 80 that the CGBM is available 103. The LIT process 100 then begins using the LIGB and the CGBM 104. At decision point 105, the LIT process 100 either continues or ends. If the LIT process 100 continues, the LIT process 100 may be informed that the CGBM is no longer available 106. The LIT process 100 then begins using only the LIGB with the scheduler 107. At decision point 108, the LiT process 100 either ends or returns to element 103.

Turning to FIG. 12, shown therein is another exemplary embodiment 120 of the allocation mechanism that employs a conditional budget monitor process, according to yet another aspect of the present invention. In this embodiment, the allocation mechanism is the recipient of the reservation command. The allocation mechanism process 120 allocates an MIGB and a GBM to the MIT 121. The allocation mechanism process 120 also allocates an LIGB and conditionally allocates a CGBM to the LIT 122. The allocation mechanism explicitly informs the MIT of its allocations 123. The allocation mechanism also explicitly informs the LIT of its allocations 124. The allocation mechanism sends a command reservation in accordance with the allocations of the MIT and LIT 125. The allocation mechanism then waits until it is triggered by some event 126. If the budgets are inadequate as determined in decision element 127, the allocation mechanism process returns to element 121. If the budgets are adequate, the allocation mechanism process 120 moves to element 128. The MIT and LIT roles expire 128, and the process ends.

Turning to FIG. 13, shown therein is an exemplary embodiment of a Conditional Budget Monitor (CBM) process 130 according to another aspect of the present invention. The CBM receives the reservation commands for the MIT and LIT 131, and sends the reservations (MIGB+GBM for MIT and LIGB for LIT) to the scheduler 132. The CBM then waits for an event. At decision point 133, the CBM process 130 continues or ends. If the CBM process 130 continues, at some point the CBM process may receive a message from the MIT indicating the MIT no longer requires its GBM 134. The CBM then sends a reservation. (MIGB for MIT and LIGB+CGBM for LIT) to the scheduler 135. The CBM then waits for an acknowledgement 136. The CBM then informs the LIT of the budget increase 137. The CBM then waits for an event 138. At decision point 139, the process 130 either continues or ends. If the process 130 continues, at some point the CBM may receive a message from the MIT indicating the MIT now requires its GBM 1310. The CBM informs the LIT of the budget decrease 1311. Preferably, this message should reach LIT before the resources are taken away, the success of which will depend on many factors, such as distances involved, clock timing, processor speed, etc.

Turning to FIG. 14, shown therein is another exemplary embodiment of a scheduling process 140 according to still another aspect of the present invention. The scheduler will receive reservation commands for one or more tasks 141 (e.g., from the CBM of FIG. 13). In element 142, the scheduler will then grant the reservation requests or modifications from element 141. The scheduler will then acknowledge the reservation command to the sender of the reservation command (e.g., the CBM of FIG. 13) 143. The scheduling process then will execute in accordance with the scheduling algorithm 144. The process 140 will either continue to element 141 or end in decision element 145. If the process 140 continues, it will proceed to element 141.

Turning to FIG. 15, shown therein is an exemplary embodiment 150 of the interaction of the MIT with the various other tasks from FIGS. 12-14. The MIT is informed of the MIGB and the GBM 91 (e.g., by the Allocation Mechanism) 151. The MIT begins using the MIGB and the GBM with the scheduler 152. The MIT determines that it does not require the GBM 153, and sends a message to this effect (e.g., to the CBM, which in turn informs the scheduler) 154. The MIT then begins using the MIGB only 155. At decision point 156, the process 150 either continues or ends. If the process 150 continues, the MIT may determine that it now requires its GBM 157. The MIT sends a message that it now requires its GBM 158 (e.g., to the CBM, which in turn informs the scheduler), and the MIT begins using the MIGB and the GBM with the scheduler 159. At decision point 1510, the process 150 either ends or returns to element 153.

Turning to FIG. 16, shown therein is an exemplary embodiment 160 of the interaction of the LIT with the various other tasks of FIGS. 12-15. The LIT is informed by the allocation mechanism of the LIGB and the CGBM 161. The LIT begins using the LIGB with the scheduler 162. At some point the LIT may be informed (e.g., by the CBM) that the CGBM is available 163. The LIT then begins using the LIGB and the CGBM 164. At decision point 165, the process 160 either continues or ends. If the process 160 continues, the LIT may be informed (e.g., by the CBM) that the CGBM is no longer available 166. The LIT then begins using only the LIGB with the scheduler 167. At decision point 168, the process 160 either ends or returns to element 163.

Turning to FIG. 17, shown therein is an exemplary embodiment 170 of the interaction of the various processes of FIGS. 1-16 according to another aspect of the present invention. An application manager 171 assigns and de-assigns the MIT role to a given task (elements 11 and 14 of FIG. 1). The application manager also assigns and de-assigns the LIT role to another given task (elements 12 and 15). The application manager 171 then becomes inactive while the allocation mechanism 172 becomes active (element 13 of FIG. 1). When the MIT and LIT roles expire (element 57 of FIG. 5), the application manager 171 becomes active again, while the allocation mechanism 172 becomes inactive. The allocation mechanism 172 allocates the MIGB and the GBM to the MIT (element 121) and explicitly informs the MIT of these allocations (element 123). The allocation mechanism 172 also allocates the LIGB and the CGBM to the LIT (element 123) and explicitly informs the LIT of these allocations (element 124). The allocation mechanism 172 sends the reservation to the CBM 176 (element 125), which executes process 130 of FIG. 13. The CBM sends the reservation to the scheduler process 140 of FIG. 14 (element 132), which executes to completion. The CBM receives messages from the MIT that the MIT no longer requires the GBM (element 134) and messages from the MIT that the MIT now requires the GBM (element 1310). In turn, the CBM sends messages, respectively, to the LIT that the CGBM is available (element 137) and that the CGBM is no longer available (element 1311). In addition, the CBM sends reservation changes to the scheduler (elements 142) and receives acknowledgements (element 143) from the scheduler. The scheduler 173 accepts reservation commands for the LIT and the MIT from the CBM (element 121), grants the MIGB and GBM to the MIT and also grants the LIGB to the LIT (element 142). The scheduler then runs in accordance with a scheduling algorithm (element 143). Changes in the reservations are sent by the scheduler 173 to the LIT and MIT (element 142). Acknowledgements of these changes are sent by the scheduler 173 to the sender (element 143).

Turning to FIG. 18, shown therein is a time flow of an exemplary embodiment 180 of a method for controlling multiple processes according to yet another aspect of the present invention. The exact order of the processes set forth in FIG. 18 is not significant, however, the order in time is important relative to some processes, which will be indicated when discussing these processes. Where not so indicated, the relative order could be varied. Upon start 181, the following process can occur for a two-process system. A similar process would occur for a three-process system, in which case the interaction would be similar between any two processes in the hierarchy.

First, the relative priorities must be established. The allocation mechanism or some other process assigns the levels of priorities to the two tasks. One of these tasks is assigned to be the More Important Task 182, in which case the allocation mechanism may inform this process of its priority designation. The other of these tasks is assigned to be the Less Important Task 184, in which case the allocation mechanism may inform this process of its priority designation. The order in which the tasks are assigned priorities is not necessarily important. For example, the lower priority task could be assigned first, hence element 184 could occur prior to element 182.

Once the priorities are assigned, each of the tasks is explicitly informed of its budget. For example, the allocation mechanism explicitly informs the MIT about the More Important Guaranteed Budget and the Guaranteed Budget Margin 183. The allocation mechanism also explicitly informs the LIT about the Less Important Guaranteed Budget 185 and the Conditionally Guaranteed Budget Margin. The order of processes 183 and 185 is not important other than each of them must occur after assignment of the relative priorities. Moreover, the informing of MIT budgets can occur immediately after the assignment of the MIT or after all priorities have been assigned. The informing of the LIT budget can occur before or after the informing of the MIT budget. The only requirement is that the informing of the budgets can only occur after assignment of the relative priorities.

After informing the MIT about its budget, the scheduler provides the More Important Guaranteed Budget plus the Guaranteed Budget Margin to the MIT at the first possible occasion 186. This provisioning of the MIT budget can occur before or after the informing the LIT about the Less Important Guaranteed Budget, and might even occur as early as immediately following assignment of the relative priorities to enable the MIT to begin using the MIT budget upon being so informed.

Subsequent to provisioning the MIT budget, the scheduler provides the Less Important Guaranteed Budget to the LIT at the first possible occasion 187. This will normally occur after the provisioning of the MIT budget due to the relative priorities of the two tasks, but could occur as early as following assignment of the relative priorities to enable the LIT to begin using the LIT budget upon being so informed.

At some point during execution, the MIT may observes that it can do its job with its More Important Guaranteed Budget only, in which case the MIT informs the scheduler of this observation 188. This can only occur after provisioning of the MIT budgets, but could occur at any point thereafter in the budget period. For simplicity purposes, the observation and the informing of the scheduler are shown as a single element, but they could be separated in time.

Once informed about the MIT's observation, the scheduler stops providing the Guaranteed Budget Margin to the MIT at the first possible occasion 189. This most likely will occur immediately following receipt of the information by the scheduler to enable use of the Guaranteed Budget Margin as early as possible. Once this condition (i.e., that the MIT does not require the Guaranteed Budget Margin) is determined to exist by the MIT, the system should make use of the Guaranteed Budget Margin as quickly as possible because this condition may not exist forever (or at least for the remainder of the budget period).

Subsequent to stopping providing the Guaranteed Budget Margin to the MIT 189, the scheduler starts providing the Conditionally Guaranteed Budget Margin to the LIT at the first possible occasion 190. The scheduler then informs the LIT of this additional budget provision 191. Preferably this informing 191 should occur after provisioning of the Conditionally Guaranteed Budget Margin 190 so that the LIT can begin using the extra budget without delay, however, in some situations these two elements 190, 191 may occur in different order.

At some point during execution in the same budget period, the MIT may observes that it now requires its Guaranteed Budget Margin as well 192. This can occur at any time after element 188, and depending when thereafter some of the elements (i.e., 189, 190 and 191) may be affected. After this new determination, the MIT explicitly informs the scheduler that it does require its Guaranteed Budget Margin 192. As before, these two sub-steps may occur separated in time, however for simplicity purposes they are shown as a single element.

After receiving this information, the scheduler informs the LIT that Conditionally Guaranteed Budget Margin will be withdrawn 193. Typically, this should occur before the scheduler stops providing this budget margin to the LIT to prevent improper use of resources and to enable the LIT to adjust accordingly and enable a smooth transition.

The scheduler then stops providing the Conditionally Guaranteed Budget Margin to the LIT at the first possible occasion 194. The scheduler then starts providing the Guaranteed Budget Margin to the MIT at the first possible occasion 195. The scheduler should first stop providing the extra budget to the LIT before providing the MIT with the extra budget to prevent improper use of resources and to enable a smooth transition.

At some point in time, the process ends 196; however, several other iterations of the elements 188-195 could occur depending upon application specifics. Moreover, the MIT may never determine it does not need the Guaranteed Budget Margin 188, or the MIT may never determine it needs the Guaranteed Budget Margin 192 after determining it does not need the Guaranteed Budget Margin 188.

1. Between an explicit grant and an explicit withdrawal of the Conditionally Guaranteed Budget Margin, the LIT can really count on the CGBM. Without the present invention, an LIT can never really count on its Conditionally Guaranteed Budget Margin.

2. There is no need for a separate entity that detects the structural load increase, because a local control algorithm within the MIT application performs this detection as a by-product of its normal activity.

3. The local algorithm in the MIT can detect the structural load changes faster than a separate entity could, because it has a semantic interpretation for the resource usage measures.

4. Since the LIT is explicitly informed about the availability of Conditionally Guaranteed Budget Margin, the LIT can react faster and more smoothly to the change. This advantage is a direct consequence of the Modified Budget Allocation Protocol (step (b)) discussed earlier.

5. The MIT does not need to know the identity of the LIT; the MIT does not even need to know that there is an LIT.

The main advantage of the basic process (as described in FIGS. 1-5) remains valid. The allocation mechanism is not involved in a budget transfer. This strongly reduces the overhead. As an example, there is no need for an admission test for the new situation, or a negotiation phase to determine the new quality level at which the various entities are running.

In case of a synchronous MIT, it is possible to achieve several of the advantages with a degenerated version of Modified Budget Allocation Protocol (step (b)) discussed earlier. According to yet another aspect of the present invention, an exemplary embodiment of a computer readable media has encoded thereon programming instructions that control a processor to perform the above-mentioned processes and methods. For example, the processor is caused to perform the methods set forth in FIGS. 1-18. Examples of computer readable media include without limitation CD-ROMs, DVDs, magnetic memory storage, RAM, ROM, hard drives, memory sticks, optical memory, etc.

The use of the present invention can be traced because it requires explicit additional interfaces.

Additional MIT Interface:

Set_budgets(in MIGB_value: budget_type; in GBM_value: budget_type);//called by AM

Additional LIT Interface:

Set_budgets(in LIGB_value: budget_type; in CGBM_value: budget_type);//called by AM
CGBM_available( );/called by scheduler.
CGBM_not_available( ); called by scheduler.
Additional Scheduler Interface:
GBM_required (in tid, task id);//called by MIT.
GBM_not_required(in tid, task id)//called by MIT.

The above inventions are applicable to televisions, receivers, audio-video processors, digital processors, set-top boxes, and other consumer electronics.

Although various embodiments are specifically illustrated and described herein, it will be appreciated that modifications and variations of the invention are covered by the above teachings and are within the purview of the appended claims without departing from the spirit and intended scope of the invention. For example, certain terms and protocols are employed, however, other names and protocols could be used without departing from the scope of the present invention. Furthermore, this example should not be interpreted to limit the modifications and variations of the invention that are covered by the claims but is merely illustrative of possible variations.

1. A method (60) for controlling multiple tasks (114, 115; 174,175) comprising:
assigning (61) a first task to be a More Important Task (114, 174);
assigning (62) a second task to be a Less Important Task (115; 175);
allocating (63) a Guaranteed Budget Margin to the More Important Task (114; 174) along with a More Important Guaranteed Budget and explicitly informing the More Important Task of this allocation;
allocating (64) a Less Important Guaranteed Budget to the Less Important Task (115; 175) and explicitly informing the Less Important Task about this allocation;
sending (67) a message that the More Important Task (114; 174) no longer requires the Guaranteed Budget Margin; and
allocating (68) a Conditionally Guaranteed Budget Margin to the Less Important Task (115; 175) and explicitly informing the Less Important Task of this allocation.

2. The method according to claim 1, further comprising determining (66) that the More Important Task (114; 174) no longer requires the Guaranteed Budget Margin.

3. A method (60; 90; 150) for operating a first task (114; 174), which first task (114; 174) has been assigned a higher level of priority than a second task (115; 175) comprising:
determining (66; 69; 93; 97; 153; 157) whether the first task (114; 174) requires additional budget margin; and
sending a message that either the additional budget margin is no longer required (67; 94; 154) or that the additional budget margin is now required (691; 98; 158).

4. The method according to claim 3, further comprising allocating (68) a conditionally guaranteed budget margin automatically to the second task (115; 175) upon receiving the message that the first task (114; 174) no longer requires the additional budget margin.

5. A method (70; 190) for controlling two or more tasks (114, 115; 174, 175) of a multi-task process comprising:
explicitly informing (73; 183) a first task (114; 174) that is a more important task about a More Important Guaranteed Budget and a Guaranteed Budget Margin;
explicitly informing (74; 184) a second task (115; 175) that is a less important task about a Less Important Guaranteed Budget and a Conditionally Guaranteed Budget Margin;
providing (82; 186) the More Important Guaranteed Budget plus the Guaranteed Budget Margin to the first task (114; 174) at a first possible occasion;
providing (82; 187) the Less Important Guaranteed Budget to the second task (115; 175) at a first possible occasion;
upon the first task (114; 174) determining (93; 188) at some point during execution that the first task (114; 174) can do its job with the More Important Guaranteed Budget only, explicitly informing (94; 188) a scheduler (113; 173) that the first task (114; 174) does not require its Guaranteed Budget Margin.

6. The method according to claim 5, further comprising:
stopping (189) to provide the Guaranteed Budget Margin to the first task (114; 174) at a first possible occasion.

7. The method according to claim 6, further comprising:
starting (190) to provide the Conditionally Guaranteed Budget Margin to the second task (115; 175) at a first possible occasion.

8. The method according to claim 7, further comprising:
informing (191) the second task (115; 175) of the providing the Conditionally Guaranteed Budget Margin.

9. The method according to claim 7, further comprising:
determining (192) by the first task (114; 174) at some point during execution that the first task (114; 174) requires the Guaranteed Budget Margin.

10. The method according to claim 9, further comprising: explicitly informing (192) the scheduler (113; 173) that the first task (114; 174) does require its Guaranteed Budget Margin.

11. The method according to claim 10, further comprising:
informing (193) the second task (115; 175) that the Conditionally Guaranteed Budget Margin will be withdrawn.

12. The method according to claim 11, further comprising:
stopping (194) to provide the Conditionally Guaranteed Budget Margin to the second task (115; 175) at a first possible occasion.

13. The method according to claim 11, further comprising:
starting (195) to provide the Guaranteed Budget Margin to the first task (114; 174) at a first possible occasion.

14. An apparatus (110) comprising:
a first task (114) having a first priority level;
a second task (115) having a second priority level lower than the first priority level;
an allocation mechanism (112) to allocate budgets of resources, said allocation mechanism (112) explicitly informing the first (114) task about a More Important Guaranteed Budget and a Guaranteed Budget Margin and explicitly informing the second task (115) about a Less Important Guaranteed Budget and a Conditionally Guaranteed Budget Margin; and
a scheduler (113) providing the budgeted amounts to the first and second tasks (114, 115), said scheduler (113) providing the More Important Guaranteed Budget plus the Guaranteed Budget Margin to the first task (114) at a first possible occasion and providing the Less Important Guaranteed Budget to the second task (115) at a first possible occasion, wherein upon the first task (114) determining at some point during execution that the first task (114) can execute properly with the More Important Guaranteed Budget only, said first task (114) explicitly informing the scheduler (113) that the first task (114) does not require its Guaranteed Budget Margin.

15. The apparatus according to claim 14, wherein the scheduler (113) stops providing the Guaranteed Budget Margin to the first task (114) at a first possible occasion and starts providing the Conditionally Guaranteed Budget Margin to the second task (115) at a first possible occasion.

16. The apparatus according to claim 15, wherein the scheduler (113) informs the second task (115) of the providing the Conditionally Guaranteed Budget Margin.

17. The apparatus according to claim 14, wherein the first task (114) determines at some point during execution that the first task requires the Guaranteed Budget Margin as well and the first task explicitly informs the scheduler (113) that the first task (114) does require its Guaranteed Budget Margin.

18. The apparatus according to claim 17, wherein the scheduler (113) informs the second task (115) that the Conditionally Guaranteed Budget Margin will be withdrawn.

19. The apparatus according to claim 18, wherein the scheduler (113) stops providing the Conditionally Guaranteed Budget Margin to the second task (115) at a first possible occasion.

20. The apparatus according to claim 19, wherein the scheduler (113) starts providing the Guaranteed Budget Margin to the first task (114) at a first possible occasion.

21. An apparatus (170) comprising:
a first task (174) having a first priority level;
a second task (175) having a second priority level lower than the first priority level;
an allocation mechanism (172) to allocate budgets of resources, said first task being explicitly informed about a More Important Guaranteed Budget and a Guaranteed Budget Margin and said second task being explicitly informing about a Less Important Guaranteed Budget and a Conditionally Guaranteed Budget Margin;
a conditional budget monitor (176) to monitor an availability of the Conditionally Guaranteed Budget Margin, said conditional budget monitor to receive a message that the More Important Task (174) no longer requires the Guaranteed Budget Margin, to receive a message that the More Important Task (174) now requires the Guaranteed Budget Margin, to receive budget allocations of the Guaranteed Budget Margin, the Conditionally Guaranteed Budget Margin, the More Important Guaranteed Budget and the Less Important Guaranteed Budget from the allocation mechanism (172), and to send out a reservation command regarding the budget allocations; and
a scheduler (173) providing the budgeted amounts to the first and second tasks (174, 175) based on the reservation command, said scheduler (173) providing the More Important Guaranteed Budget plus the Guaranteed Budget Margin to the first task (174) at a first possible occasion and providing the Less Important Guaranteed Budget to the second task (175) at a first possible occasion, wherein upon the first task (174) determining at some point during execution that the first task (174) can execute properly with the More Important Guaranteed Budget only, said conditional budget monitor (176) sending a reservation command to the scheduler (173) including only the More Important Guaranteed Budget for the first task (174) and including the Conditionally Guaranteed Budget Margin along with the Less Important Guaranteed Budget for the second task (175).

22. The apparatus according to claim 21, wherein upon the first task determining that is now requires the Guaranteed Budget Margin, and communicating this to the conditional budget monitor, the conditional budget monitor (176) sending a reservation command to the scheduler (173) including the Guaranteed Budget Margin and the More Important Guaranteed Budget to the first task (174) and the Less Important Guaranteed Budget only to the second task (175).

23. The apparatus according to claim 21, wherein the conditional budget monitor (173) informs the second task (175) of the providing the Conditionally Guaranteed Budget Margin.

24. The apparatus according to claim 22, wherein the conditional budget monitor (173) informs the second task (175) that the Conditionally Guaranteed Budget Margin will be withdrawn.
